(19) United States
(12) Patent Application Publication
(10) Pub. No.: US 2023/0137413 A1
(43) Pub. Date: May 4, 2023

(54) LITHIUM SECONDARY BATTERY AND METHOD FOR USING SAME

(71) Applicant: TeraWatt Technology K.K., Yokohama-shi (JP)

(72) Inventors: Masatsugu Nakano, Yokohama-shi (JP); Ken Ogata, Yokohama-shi (JP)

(73) Assignee: TeraWatt Technology K.K., Yokohama-shi (JP)

(21) Appl. No.: 18/087,161

(22) Filed: Dec. 22, 2022

Related U.S. Application Data
(63) Continuation of application No. PCT/JP2020/025079, filed on Jun. 25, 2020.

(51) Int. Cl. H01M 4/131; H01M 10/44

(52) U.S. Cl. CPC H01M 4/131; H01M 10/441; H01M 2004/028

(57) ABSTRACT

The present invention provides a lithium secondary battery that has high energy density and excellent cycle characteristics, and a method for using this battery. The present invention relates to a lithium secondary battery comprising: a positive electrode current collector; a positive electrode formed on at least one surface of the positive electrode current collector and having a positive electrode active material; a negative electrode free of a negative electrode active material; and a separator or solid electrolyte disposed between the positive electrode and the negative electrode, wherein the positive electrode contains a Li(Ni, Co, Mn)O₂ crystal and/or a Li(Ni, Co, Al)O₂ crystal whose full width at half maximum for the diffraction peak of the (003) plane as measured by X-ray diffraction that is greater than 0.00° and 0.10° or less in an amount of 20% by mass or more and 100% by mass or less relative to the total mass of the positive electrode active material.

### CROSS-REFERENCE TO RELATED APPLICATIONS

This application is a continuation of International Application No. PCT/JP2020/025079, filed Jun. 25, 2020, the entire contents of which are incorporated herein by reference.

### TECHNICAL FIELD

The present invention relates to a lithium secondary battery and to a method for using this battery.

### BACKGROUND ART

In recent years, techniques for converting natural energy such as solar power or wind power into electric energy have attracted more attention. Accordingly, various secondary batteries have been developed as storage devices that are safe and that can store a large amount of electric energy.

Among these, secondary batteries that charge and discharge by transferring metal ions between a positive electrode and a negative electrode are known to have a high voltage and high energy density, and are usually lithium ion secondary batteries. In a typical lithium ion secondary battery, an active material capable of retaining lithium is introduced into the positive electrode and the negative electrode, and charging and discharging are performed by exchanging lithium ions between the positive electrode active material and the negative electrode active material. A lithium metal secondary battery has also been developed as a secondary battery that does not use an active material in the negative electrode but that retains lithium by depositing lithium metal on the surface of the negative electrode.

For example, Patent Document 1 discloses a high energy density, high power lithium metal anode secondary battery with a volumetric energy density greater than 1000 Wh/L and/or a mass energy density greater than 350 Wh/kg when discharged at room temperature at a rate of at least 1C. Patent Document 1 discloses that an ultrathin lithium metal anode is used to realize this lithium metal anode secondary battery.

Patent Document 2 discloses a lithium secondary battery containing a positive electrode, a negative electrode, a separation film interposed between the electrodes, and an electrolyte. In the negative electrode of this lithium secondary battery, metal particles are formed on the negative electrode current collector and move from the positive electrode during charging to form lithium metal on the negative electrode current collector in the negative electrode. Patent Document 2 discloses that this lithium secondary battery can solve problems caused by the reactivity of lithium metal and problems that occur during the assembly process, and that can provide a lithium secondary battery with improved performance and a longer service life.

### CITATION LIST

### Patent Literature

Patent Document 1: JP 2019-517722 A
Patent Document 2: JP 2019-537226 A

### SUMMARY OF INVENTION

### Technical Problem

When the present inventors studied batteries of the prior art including those described in the patent documents mentioned above, they found that all of them were insufficient in terms of at least energy density and cycle characteristics.

For example, a typical secondary battery that charges and discharges by transferring metal ions between a positive electrode active material and a negative electrode active material does not have sufficient energy density. Meanwhile, in lithium metal secondary batteries that retain lithium by depositing lithium metal on the surface of the negative electrode, such as those described in the patent documents listed above, dendrites tend to form on the surface of the negative electrode after repeated charging and discharging, which makes short-circuiting and capacity loss more likely to occur. As a result, the cycle characteristics are not sufficient.

A method has also been developed of applying a large amount of physical pressure to a lithium metal secondary battery to keep the interface between the negative electrode and the separator under high pressure and suppress discrete growth during lithium metal precipitation. However, because a large mechanical mechanism is required to apply such a high level of pressure, the weight and volume of the battery increase as a whole, and the energy density decreases.

In view of these problems, it is an object of the present invention to provide a secondary battery having high energy density and excellent cycle characteristics and a method for using this battery.

### Solution to Problem

One aspect of the present invention is a lithium secondary battery comprising: a positive electrode current collector; a positive electrode formed on at least one surface of the positive electrode current collector and having a positive electrode active material; a negative electrode free of a negative electrode active material; and a separator or solid electrolyte disposed between the positive electrode and the negative electrode, wherein the positive electrode contains a Li(Ni, Co, Mn)O₂ crystal and/or a Li(Ni, Co, Al)O₂ crystal whose full width at half maximum for the diffraction peak of the (003) plane as measured by X-ray diffraction is greater than 0.00° and 0.10° or less in an amount of 20% by mass or more and 100% by mass or less relative to the total mass of the positive electrode active material.

By providing a lithium secondary battery with a negative electrode that is free of a negative electrode active material, charging and discharging are performed by depositing lithium metal on the surface of the negative electrode and electrolytically eluting the deposited lithium metal, which increases the energy density. Also, because in the lithium secondary battery containing the above-mentioned positive electrode, the positive electrode responds to the charging and discharging in a moderate range, not all of the lithium metal deposited on the negative electrode dissolve during a discharge, and some of the lithium metal remains on the negative electrode once the discharge is finished. Because the lithium metal remaining on the negative electrode serves as scaffolding for deposition of lithium metal on the negative electrode during subsequent charging, the lithium metal tends to be deposited uniformly on the negative electrode during charging. As a result, the growth of dendritic lithium metal on the negative electrode is suppressed, and the lithium secondary battery has excellent cycle characteristics.

The Li(Ni, Co, Mn)O₂ is preferably LiNi_{1-x-y}CoₓMn_{y}O₂ (where 0.05≤x≤0.20 and 0.01≤y≤0.15), and the Li(Ni, Co, Al)O₂ is preferably LiNi_{1-x-y}CoₓAl_{y}O₂ (where 0.05≤x≤0.20 and 0.01≤y≤0.15). In this aspect, the discharge efficiency of the lithium secondary battery can be kept within a more moderate range, which tends to improve the energy density and cycle characteristics of the lithium secondary battery.

The amount of positive electrode active material relative to the overall mass of the positive electrode is preferably 50% by mass or more and 100% by mass or less. In this aspect, the discharge efficiency of the lithium secondary battery can be kept within a more moderate range, which tends to improve the energy density and cycle characteristics of the lithium secondary battery.

The lithium secondary battery is preferably a lithium secondary battery in which charging and discharging are performed by depositing lithium metal on the surface of the negative electrode and dissolving the deposited lithium. In this aspect, the energy density is further improved.

The negative electrode is preferably an electrode consisting of at least one selected from the group consisting of Cu, Ni, Ti, Fe, other metals that do not react with Li, alloys of these, and stainless steel (SUS). This aspect does not require the use of highly flammable lithium metal during production, so safety and productivity are further improved. Also, because the negative electrode is stable, the cycle characteristics of the secondary battery are further improved.

In the lithium secondary battery according to this aspect of the present invention, lithium foil is preferably not formed on the surface of the negative electrode before initial charging. This aspect does not require the use of highly flammable lithium metal during production, so safety and productivity are further improved.

The lithium secondary battery according to one aspect of the present invention can be used under charging conditions of 4.4 V or more. Because the positive electrode in the lithium secondary battery according to this aspect of the present invention contains a Li(Ni, Co, Mn)O₂ crystal and/or a Li(Ni, Co, Al)O₂ crystal whose full width at half maximum for the diffraction peak of the (003) plane as measured by X-ray diffraction is greater than 0.00° and 0.10° or less in an amount of 20% by mass or more and 100% by mass or less relative to the total mass of the positive electrode active material, the positive electrode of the battery has higher durability against high voltage than that of a typical lithium secondary battery. Therefore, when the lithium secondary battery according to this aspect of the present invention is used under charging conditions of 4.4 V or higher, charging can be performed without damaging the positive electrode. Also, when the lithium secondary battery is used under charging conditions of 4.4 V or more, the amount of lithium metal remaining on the negative electrode after discharging is even higher, which tends to improve the cycle characteristics.

### Effect of Invention

The present invention is able to provide a secondary battery having high energy density and excellent cycle characteristics and a method for using this battery.

### BRIEF DESCRIPTION OF DRAWINGS

FIG. 1 is a schematic cross-sectional view of the lithium secondary battery in a first embodiment of the present invention.

FIG. 2 is a schematic cross-sectional view of the lithium secondary battery in the first embodiment during use.

FIG. 3 is a schematic cross-sectional view of the lithium secondary battery in a second embodiment of the present invention.

### DESCRIPTION OF EMBODIMENTS

Embodiments of the present invention (“embodiments”) will now be described with reference to the drawings when necessary. In the drawings, identical elements are designated by the same reference numbers, and redundant descriptions of these elements have been omitted. Positional relationships such as up, down, left, and right are based on the positional relationship shown in the drawings unless otherwise specified. The dimensional ratios shown in the drawings are not limited to the depicted ratios.

### 1st Embodiment

### Lithium Secondary Battery

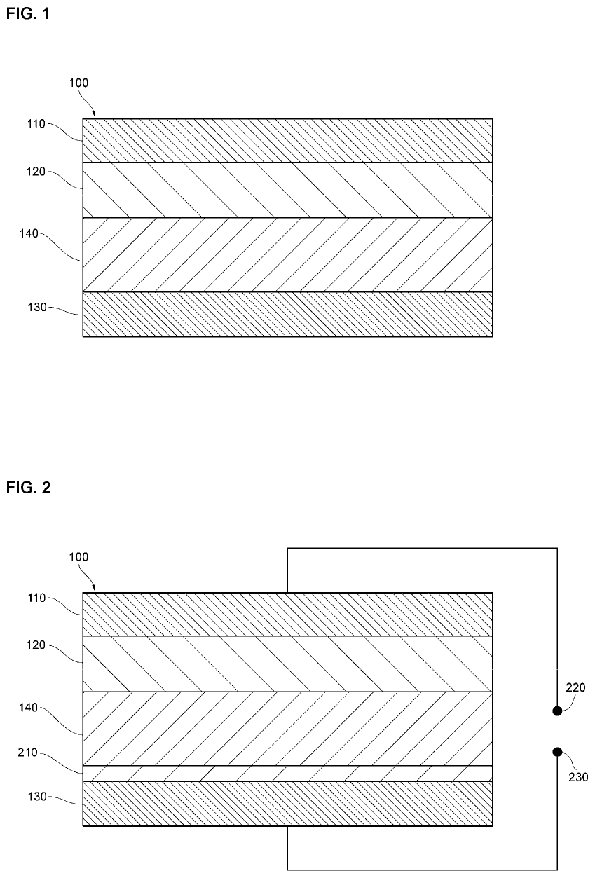

FIG. 1 is a schematic cross-sectional view of the lithium secondary battery in a first embodiment of the present invention. As shown in FIG. 1, the lithium secondary battery 100 in the first embodiment comprises a positive electrode current collector 110, a positive electrode 120 including a positive electrode active material and formed on one side of the positive electrode current collector 110, a negative electrode 130 free of a negative electrode active material, and a separator 140 disposed between the positive electrode 120 and the negative electrode 130.

### Negative Electrode

The negative electrode 130 does not contain a negative electrode active material. It is difficult to increase the energy density of a lithium secondary battery with a negative electrode containing a negative electrode active material due to the presence of the negative electrode active material. On the other hand, because the lithium secondary battery 100 in the present embodiment has a negative electrode 130 that does not contain a negative electrode active material, this problem does not occur. In other words, the lithium secondary battery 100 in the present embodiment has a high energy density because charging and discharging are performed by depositing lithium metal on the surface of the negative electrode 130 and electrolytically eluting the deposited lithium metal.

In the present specification, “negative electrode active material” refers to a material holding the lithium ions or lithium metal serving as the charge carrier (“carrier metal” below) on the negative electrode 130, and may also be referred to as the carrier metal host material. Examples of holding mechanisms include, but are not limited to, intercalation, alloying, and occlusion of metallic clusters.

Examples of negative electrode active materials include, but are not limited to, carbon-based substances, metal oxides, metals, and alloys. Carbon-based substances include, but are not limited to, graphene, graphite, hard carbon, mesoporous carbon, carbon nanotubes, and carbon nanohorns. Examples of metal oxides include, but are not limited to, titanium oxide-based compounds, tin oxide-based compounds, and cobalt oxide-based compounds. There are no particular restrictions on the metal or alloy as long as it can be alloyed with the carrier metal. Examples of metals and alloys include silicon, germanium, tin, lead, aluminum, gallium, and alloys containing them.

There are no particular restrictions on the negative electrode 130 as long as it does not contain a negative electrode active material and can be used as a current collector. Examples of negative electrode include electrodes consisting of at least one selected from the group consisting of Cu, Ni, Ti, Fe and other metals that do not react with Li, alloys of these metals, and stainless steel (SUS). When SUS is used as the negative electrode 130, any well-known type of SUS can be used. The negative electrode materials mentioned above may be used alone or in combinations of two or more. In the present specification, a “metal that does not react with Li” refers to a metal that does not react with lithium ions or lithium metal to form an alloy under the operating conditions of the secondary battery.

The negative electrode 130 is preferably a lithium-free electrode. Because highly flammable lithium metal does not have to be used in the production process, a secondary battery 100 with even better safety and productivity can be obtained. From this standpoint and from the standpoint of improving the stability of the negative electrode 130, the negative electrode 130 is preferably an electrode consisting of at least one selected from the group consisting of Cu, Ni, alloys of these metals, and stainless steel (SUS). From the same standpoints, the negative electrode 130 is more preferably an electrode consisting of Cu, Ni, or alloys these metals, and even more preferably an electrode consisting of Cu or Ni.

In the present specification, a “negative electrode free of a negative electrode active material” means the amount of negative electrode active material in the negative electrode is 10% by mass or less relative to the overall mass of the negative electrode. The amount of negative electrode active material in the negative electrode relative to the overall mass of the negative electrode is preferably 5.0% by mass or less, more preferably 1.0% by mass or less, even more preferably 0.1% by mass or less, and still more preferably 0.0% by mass or less. A secondary battery 100 having a negative electrode that is free of a negative electrode active material means that a secondary battery 100 is an anode-free secondary battery, a zero-anode secondary battery, or an anodeless secondary battery in the general sense of these terms.

In a typical lithium ion secondary battery, the capacity of the negative electrode active material in the negative electrode is set so as to be the same as the capacity of the positive electrode. Therefore, when the capacity of the negative electrode active material in the negative electrode 130 is lower than the capacity of the positive electrode 120, even when, for example, it is 20% or less, 15% or less, 10% or less, or 5% or less, the negative electrode is referred to as “negative electrode free of a negative electrode active material.”

The average thickness of the negative electrode 130 is preferably 4 μm or more and 20 μm or less, more preferably 5 μm or more and 18 μm or less, and even more preferably 6 μm or more and 15 μm or less. Because the volume occupied by the negative electrode 130 in the secondary battery 100 is reduced in this aspect of the present invention, the energy density of the secondary battery 100 is further improved.

### Positive Electrode Current Collector

There are no particular restrictions on the positive electrode current collector 110 as long as it is a conductor that does not react with lithium ions in a battery. An example of such a positive electrode current collector is aluminum.

### Positive Electrode

The positive electrode 120 includes a positive electrode active material and is formed on one side of the positive electrode current collector 110. The lithium secondary battery 100 in the present embodiment contains Li(Ni, Co, Mn)O₂ crystals and/or Li(Ni, Co, Al)O₂ crystals with high crystallinity, specifically, Li(Ni, Co, Mn)O₂ crystals and/or Li(Ni, Co, Al)O₂ crystals whose full width at half maximum for the diffraction peak of the (003) plane as measured by X-ray diffraction is greater than 0.00° and 0.10° or less, in an amount of 20% by mass or more and 100% by mass or less relative to the total mass of the positive electrode 120 active material.

In the present specification, “positive electrode active material” refers to a material used to retain the carrier metal on the positive electrode in the battery, and may be referred to as a host material for the carrier metal.

In general, because a positive electrode active material with low crystallinity, which may be referred to as polycrystalline positive electrode active material, is more responsive to charging and discharging than a positive electrode active material with high crystallinity and can efficiently transfer the carrier metal, the polycrystalline positive electrode active material is more commonly used in order to improve the energy density and cycle characteristics of the positive electrode in a typical lithium secondary battery. Therefore, it may be expected that the use of the polycrystalline positive electrode active material is the preferred choice even in a lithium secondary battery with a negative electrode that is free of a negative electrode active material. However, contrary to the expectation, the present inventors have discovered that a lithium secondary battery containing a positive electrode active material with high crystallinity within the predetermined ratio as described above has excellent energy density and cycle characteristics. The following reason may be a factor, but others may also be involved.

When a polycrystalline positive electrode active material is used in a lithium secondary battery having a negative electrode that is free of a negative electrode active material, the polycrystalline positive electrode active material can efficiently transfer the carrier metal back and forth, so most of the lithium metal deposited on the negative electrode during a charge is electrolytically eluted during a discharge and hardly any lithium metal is believed to remain on the negative electrode at the end of a discharge. Thus, when the battery is charged again, little scaffolding is believed to remain for depositing lithium metal on the negative electrode and uniform deposition of the lithium metal becomes difficult. Therefore, in a lithium secondary battery having a negative electrode that is free of a negative electrode active material, when a polycrystalline positive electrode active material is used, lithium metal deposits tend to be non-uniform and this results in poor cycle characteristics. However, a lithium secondary battery containing a positive electrode active material with high crystallinity within a predetermined ratio, such as the lithium secondary battery 100 in the present embodiment, has a moderate response to charging and discharging of the positive electrode. Therefore, after the discharge is completed, some of the lithium metal deposited on the negative electrode during charging is not electrolytically eluted, and a certain amount of lithium metal remains on the negative electrode. Thus, when the battery is charged again, some scaffolding is believed to have remained for depositing lithium metal on the negative electrode and uniform deposition of the lithium metal is easier. Therefore, in a lithium secondary battery having a negative electrode that is free of a negative electrode active material, when a highly crystalline positive electrode active material is used, lithium metal deposits tend to be more uniform and this suppresses the growth of dendritic lithium metal.

In the present specification, “suppressing the growth of dendritic lithium metal” means suppressing the growth of lithium metal in dendritic form on the surface of the negative electrode. In other words, it means inducing non-dendritic growth of lithium metal on the surface of the negative electrode during repeated charging and discharging of the lithium secondary battery. Here, “non-dendritic form” includes, but is not limited to, plate shaped, peak shaped or valley shaped.

More specifically, the present inventors discovered that when the positive electrode 120 contains Li(Ni, Co, Mn)O₂ crystals and/or Li(Ni, Co, Al)O₂ crystals whose full width at half maximum for the diffraction peak of the (003) plane as measured by X-ray diffraction is greater than 0.00° and 0.10° or less, in an amount of 20% by mass or more and 100% by mass or less relative to the total mass of the positive electrode 120 active material, the energy density and cycle characteristics of the lithium secondary battery 100 are improved.

Li(Ni, Co, Mn)O₂ and Li(Ni, Co, Al)O₂ are materials commonly used as a positive electrode active material in lithium ion batteries, and are materials that can facilitate the transfer of lithium ions in and out of the crystalline structure by controlling the electric potential. Li(Ni, Co, Mn)O₂ and Li(Ni, Co, Al)O₂ can be expressed, respectively, as LiNi_{1-x-y}CoₓMn_{y}O₂ (where 0.00<x, y<1.00, and x+y<1.00) and LiNi_{1-x-y}CoₓAl_{y}O₂ (where 0.00<x, y<1.00, and x+y<1.00).

The crystallinity of Li(Ni, Co, Mn)O₂ crystals and/or Li(Ni, Co, Al)O₂ crystals can be estimated using X-ray diffraction measurements, and are known to have high crystallinity when the half width of the diffraction peak obtained in a measurement is smaller. Generally, the plane with the highest peak intensity in Li(Ni, Co, Mn)O₂ crystals and/or Li(Ni, Co, Al)O₂ crystals is the (003) plane. In the lithium secondary battery of the present embodiment, Li(Ni, Co, Mn)O₂ crystals and/or Li(Ni, Co, Al)O₂ crystals whose full width at half maximum for the diffraction peak of the (003) plane as measured by X-ray diffraction is greater than 0.00° and 0.10° or less can be said to have sufficient crystallinity to effectively and reliably exhibit the effects of the present embodiment described above. When a positive electrode is used in the lithium secondary battery in the present embodiment containing these Li(Ni, Co, Mn)O₂ crystals and/or Li(Ni, Co, Al)O₂ crystals in an amount of 20% by mass or more and 100% by mass or less relative to the total mass of the positive electrode active material, it has energy density and excellent cycle characteristics.

The full width at half maximum of the diffraction peak for the (003) plane can be measured by X-ray diffraction measurements conducted according to a known method. For example, using powder of Li(Ni, Co, Mn)O₂ or Li(Ni, Co, Al)O₂ crystals as a sample, an X-ray diffraction spectrum may be obtained from a powder X-ray diffraction measurement using CuKα rays, and the spectrum can then be analyzed. This analysis may be performed using a known method. A specific example is the method described in the examples section.

The full width at half maximum of the diffraction peak for the (003) plane of Li(Ni, Co, Mn)O₂ crystals and Li(Ni, Co, Al)O₂ crystals measured in an X-ray diffraction measurement can be measured using a scanning electron microscope (SEM) or a transmission electron microscope (TEM). For example, an electron beam backscatter diffraction measurement (EBSD) using a SEM or an electron beam diffraction measurement (ED) using a TEM may be performed.

For a positive electrode 120, the full width at half maximum of the (003) plane diffraction peak of the Li(Ni, Co, Mn)O₂ crystals and Li(Ni, Co, Al)O₂ crystals as measured by X-ray diffraction is preferably 0.01° or more, more preferably 0.02° or more, and even more preferably 0.03° or more. Also, the full width at half maximum is preferably 0.09° or less and more preferably 0.08° or less. Because the response of the positive electrode to the charging and discharging is more moderate when the full width at half maximum is within this range, the cycle characteristics of lithium secondary batteries tend to be more excellent.

Li(Ni, Co, Mn)O₂ crystals and/or Li(Ni, Co, Al)O₂ crystals whose full width at half maximum for the diffraction peak of the (003) plane as measured by X-ray diffraction is greater than 0.00° and 0.10° or less may be synthesized using a known method or obtained from a commercial source.

For a positive electrode 120, the Li(Ni, Co, Mn)O₂ preferably has a composition represented by LiNi_{1-x-y}CoₓMn_{y}O₂ (where 0.05≤x≤0.20 and 0.01≤y≤0.15). Here, x may be 0.07 or more and 0.19 or less, 0.09 or more and 0.18 or less, or 0.10 or more and 0.17 or less. Also, y may be 0.02 or more, 0.12 or less, or 0.10 or less.

For a positive electrode 120, the Li(Ni, Co, Al)O₂ preferably has a composition represented by LiNi_{1-x-y}CoₓAl_{y}O₂ (where 0.05≤x≤0.20 and 0.01≤y≤0.15). Here, x may be 0.07 or more and 0.19 or less, 0.09 or more and 0.18 or less, or 0.10 or more and 0.17 or less. Also, y may be 0.02 or more, 0.12 or less, or 0.10 or less.

The positive electrode 120 may contain other positive electrode active material in addition to Li(Ni, Co, Mn)O₂ crystals and/or Li(Ni, Co, Al)O₂ crystals whose full width at half maximum for the diffraction peak of the (003) plane as measured by X-ray diffraction is greater than 0.00° and 0.10° or less. There are no particular restrictions on this positive electrode active material and it may be any one commonly used in lithium secondary batteries. Any known material can be selected based on the intended application for the lithium secondary battery. The positive electrode 120 may also contain Li(Ni, Co, Mn)O₂ crystals and/or Li(Ni, Co, Al)O₂ crystals whose full width at half maximum for the diffraction peak of the (003) plane as measured by X-ray diffraction is greater than 0.10°. Non-limiting examples of a positive electrode active material that can be included in the positive electrode 120 include, for example, a layered metal oxide. Examples of the layered metal oxide include, but are not limited to, cobalt oxide-based compounds, manganese oxide-based compounds, and nickel oxide-based compounds. Typical positive electrode active materials include LiCoO₂, LiNiₓMn_{y}O₂ (where x+y=1), and LiNiO₂. These positive electrode active materials may be used alone or in combinations of two or more.

The positive electrode 120 contains Li(Ni, Co, Mn)O₂ crystals and/or Li(Ni, Co, Al)O₂ crystals whose full width at half maximum for the diffraction peak of the (003) plane as measured by X-ray diffraction is greater than 0.00° and 0.10° or less in an amount of 20% by mass or more and 100% by mass or less relative to the total mass of the positive electrode 120 active material. Stated another way, in the positive electrode, the total amount of both Li(Ni, Co, Mn)O₂ crystals and Li(Ni, Co, Al)O₂ crystals whose full width at half maximum for the diffraction peak of the (003) plane as measured by X-ray diffraction is greater than 0.00° and 0.10° or less is 20% by mass or more and 100% by mass or less relative to the total mass of the positive electrode 120 active material. The total amount of both Li(Ni, Co, Mn)O₂ crystals and Li(Ni, Co, Al)O₂ crystals whose full width at half maximum for the diffraction peak of the (003) plane as measured by X-ray diffraction is greater than 0.00° and 0.10° or less may be 30% by mass or more, 40% by mass or more, or 50% by mass or more. A higher total amount of these Li(Ni, Co, Mn)O₂ crystals and Li(Ni, Co, Al)O₂ crystals tends to result in higher cycle characteristics for the lithium secondary battery.

The positive electrode 120 may contain components other than a positive electrode active material. Examples of these components include, but are not limited to, commonly used conductive aids, binders, solid polymer electrolytes, and inorganic solid electrolytes.

Examples of conductive aids that can be used in the positive electrode 120 include carbon black, single-wall carbon nanotubes (SW-CNT), multi-wall carbon nanotubes (MW-CNT), carbon nanofibers, and acetylene black. Examples of binders include polyvinylidene fluoride, polytetrafluoroethylene, styrene butadiene rubber, acrylic resins, and polyimide resins.

The amount of positive electrode active material in the positive electrode 120 relative to the overall mass of the positive electrode 120 is preferably, for example, 50% by mass or more, and may be 60% by mass or more, 70% by mass or more, 80% by mass or more, or 90% by mass or more. Also, the amount of positive electrode active material in the positive electrode 120 relative to the overall mass of the positive electrode 120 may be 100% by mass or less, 99% by mass or less, or 98% by mass or less. The amount of conductive aid relative to the overall mass of the positive electrode 120 may be, for example, 0.5% by mass or more and 30% by mass or less. The amount of binder relative to the overall mass of the positive electrode 120 may be, for example, 0.5% by mass or more and 30% by mass or less. The total amount of the solid polymer electrolyte and inorganic solid electrolyte relative to the overall mass of the positive electrode 120 may be, for example, 0.5% by mass or more and 30% by mass or less.

### Separator

The separator 140 is a component that separates the positive electrode 120 and the negative electrode 130 to prevent short circuiting, while maintaining conductivity of lithium ions serving as a charge carrier between the positive electrode 120 and the negative electrode 130. It is made of a material that does not have electronic conductivity and that does not react with lithium ions. The separator 140 also plays a role in retaining electrolytic solution. There are no particular restrictions on the separator 140 as long as it can play these roles, and examples of the separator 140 include, for example, one made of a porous material such as porous polyethylene (PE), polypropylene (PP), or a laminated structure thereof.

The separator 140 may be coated with a separator coating layer. The separator coating layer may be applied to one or both sides of the separator 140. There are no restrictions on the separator coating layer as long as it has ionic conductivity and does not react with lithium ions. It is preferable that the separator coating layer firmly bonds the separator 140 to a layer adjacent to the separator 140. Examples of the separator coating layer include, but are not limited to, one including a binder such as polyvinylidene fluoride (PVDF), styrene-butadiene rubber and carboxymethyl cellulose (SBR-CMC) mixtures, polyacrylic acid (PAA), lithium polyacrylate (Li-PAA), polyimide (PI), polyamideimide (PAI), and aramids. The separator coating layer may contain inorganic particles such as silica, alumina, titania, zirconia, magnesium oxide, magnesium hydroxide, or lithium nitrate particles.

The average thickness of the separator 140 is preferably 20 μm or less, more preferably 18 μm or less, and even more preferably 15 μm or less. Because the volume occupied by the separator 140 in the lithium secondary battery 100 is reduced in this aspect of the present invention, the energy density of the lithium secondary battery 100 is further improved. The average thickness of the separator 140 is also preferably 5 μm or more, more preferably 7 μm or more, and even more preferably 10 μm or more. This aspect of the present invention can separate the positive electrode 120 from the negative electrode 130 more reliably, and further suppress short circuiting of the battery.

### Electrolytic Solution

The lithium secondary battery 100 may have electrolytic solution. The electrolytic solution may be used to impregnate in the separator 140, or the lithium secondary battery 100 may be sealed with the electrolytic solution to obtain finished product. Electrolytic solution is solution that contains an electrolyte and a solvent, has ionic conductivity, and acts as a conductive path for lithium ions. Therefore, the internal resistance of a lithium secondary battery 100 containing electrolytic solution is reduced further, and the energy density, capacity, and cycle characteristics of the battery are improved further.

There are no particular restrictions on the electrolyte that is used. Examples of electrolyte include salts of Li, Na, K, Ca, and Mg. A lithium salt is preferably used as the electrolyte. Examples of lithium salts include, but are not limited to, LiI, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiB(O₂C₂H₄)₂, LiB(O₂C₂H₄)F₂, LiB(OCOCF₃)₄, LiNO₃, and Li₂SO₄. From the standpoint of further improving the energy density, capacity, and cycle characteristics of the lithium secondary battery 100, use of LiN(SO₂F)₂ as the lithium salt is preferred. These lithium salts can be used alone or in combinations of two or more.

Examples of solvent include, but are not limited to, dimethyl ether, diethylene glycol dimethyl ether, triethylene glycol dimethyl ether, acetonitrile, dimethyl carbonate, diethyl carbonate, ethylmethyl carbonate, ethylene carbonate, propylene carbonate, chloroethylene carbonate, fluoroethylene carbonate, difluoroethylene carbonate, trifluoromethylpropylene carbonate, methylacetate, ethylacetate, propylacetate, methylpropionate, ethylpropionate, nonafluorobutylmethyl ether, nonafluorobutylethyl ether, tetrafluoroethyltetrafluoropropyl ether, triethyl phosphate, and triethyl phosphate. These solvents are used alone or in combinations of two or more.

### Use of Lithium Secondary Battery

FIG. 2 is a schematic cross-sectional view of the lithium secondary battery in the first embodiment during use. In the lithium secondary battery 100, the positive electrode terminal 220 and the negative electrode terminal 230 used to connect the lithium secondary battery 100 to an external circuit are joined to the positive electrode current collector 110 and the negative electrode 130, respectively. The lithium secondary battery 100 is charged and discharged in connecting the negative electrode terminal 230 to one end of the external circuit and the positive electrode terminal 220 to the other end of the external circuit.

The lithium secondary battery 100 is charged by applying voltage between the positive electrode terminal 220 and the negative electrode terminal 230 so that current flows from the negative electrode terminal 230 through the external circuit to the positive electrode terminal 220. As the lithium secondary battery 100 is charged, lithium metal is deposited at the interface between the negative electrode 130 and the separator 140.

The lithium secondary battery 100 may have a solid electrolyte interface layer (SEI layer) 210 formed at the interface between the negative electrode 130 and the separator 140 during the initial charging. There are no particular restrictions on the SEI layer 210 that is formed, which may include, for example, a lithium-containing inorganic compound or a lithium-containing organic compound. A typical average thickness for the SEI layer is 1 nm or more and 10 μm or less.

When an SEI layer 210 is formed in a lithium secondary battery 100, the lithium metal deposited during charging of the lithium secondary battery 100 may be deposited on the interface between the negative electrode 130 and the SEI layer 210 or may be deposited on the interface between the SEI layer 210 and the separator 140.

When the positive electrode terminal 220 and the negative electrode terminal 230 of the charged lithium secondary battery 100 are connected, the lithium secondary battery 100 is discharged. The lithium metal deposited on at least one of the interface between the negative electrode 130 and the SEI layer 210 and the interface between the SEI layer 210 and the separator 140 is electrolytically eluted.

Because the positive electrode 120 in the lithium secondary battery 100 contains Li(Ni, Co, Mn)O₂ crystals and/or Li(Ni, Co, Al)O₂ crystals whose full width at half maximum for the diffraction peak of the (003) plane as measured by X-ray diffraction is greater than 0.00° and 0.10° or less in an amount of 20% by mass or more and 100% by mass or less relative to the total mass of the positive electrode active material, it is thought that the response of the positive electrode to charging and discharging is in a moderate range, and that not all of the lithium metal deposited on at least one of the interface between the negative electrode 130 and the SEI layer 210 and the interface between the SEI layer 210 and the separator 140 dissolve during a discharge and some of the lithium metal remains on the negative electrode once the discharge is finished. Because the lithium metal remaining during charging of the lithium secondary battery 100 after a discharge serves as scaffolding, the lithium metal is believed to be deposited uniformly on the negative electrode. As a result, the growth of dendritic lithium metal is suppressed even after repeated charging and discharging cycles, and the lithium secondary battery 100 has excellent cycle characteristics.

A typical lithium secondary battery containing Li(Ni, Co, Mn)O₂ and/or Li(Ni, Co, Al)O₂ as a positive electrode active material is normally charged only to about 4.2 V or 4.3 V. This is because polycrystalline Li(Ni, Co, Mn)O₂ and Li(Ni, Co, Al)O₂ is often used in typical lithium secondary batteries. When high voltage is applied to polycrystalline Li(Ni, Co, Mn)O₂ and Li(Ni, Co, Al)O₂, additional amorphization and phase transition (spinelization and cation migration) occur. This degrades the performance of the positive electrode active material, and significant deterioration occurs in the cycle characteristics of the battery. On the other hand, because the lithium secondary battery 100 in the present embodiment uses highly crystalline Li(Ni, Co, Mn)O₂ and Li(Ni, Co, Al)O₂ that is less likely to become amorphous or undergo a phase transition even when high voltage is applied, excellent cycle characteristics can be maintained even when the battery is charged to a voltage higher than normal.

As a result, the lithium secondary battery 100 in this embodiment can be used under charging conditions of 4.4 V or higher. When the lithium secondary battery 100 is used under charging conditions of 4.4 V or more, the amount of lithium metal deposited on the negative electrode increases during charging, and is believed to increase the amount of lithium metal remaining after the end of a discharge.

There are no particular restrictions on the charging conditions for the lithium secondary battery 100, and they may be within the range of 4.2 V to 4.3 V or may be 4.4 V or higher. Also, the charging conditions for the lithium secondary battery 100 may be 4.7 V or lower, or 4.6 V or lower.

### Secondary Battery Production Method

There are no particular restrictions on the method used to produce the lithium secondary battery 100 shown in FIG. 1 as long as it can produce a lithium secondary battery with the configuration described above. The following method is an example.

The positive electrode current collector 110 can be obtained by preparing a conductor that does not react with lithium ions in the battery and cutting it into an appropriate size. For example, a metal foil (for example, Al foil) having a thickness of 5 μm or more and 1 mm or less may be prepared and punched out to obtain the predetermined size.

The positive electrode 120 may be manufactured in the following way. First, Li(Ni, Co, Mn)O₂ crystals and/or Li(Ni, Co, Al)O₂ crystals whose full width at half maximum for the diffraction peak of the (003) plane as measured by X-ray diffraction is greater than 0.00° and 0.10° or less may be produced using a known production method or obtained from a commercial source. When obtained from a commercial source, a full width at half maximum for the diffraction peak of the (003) plane of greater than 0.00° and 0.10° or less may be selected by referring to the manufacturer's publications or a full width at half maximum for the diffraction peak of the (003) plane of greater than 0.00° and 0.10° or less may be confirmed by X-ray diffraction measurement after purchase. The resulting Li(Ni, Co, Mn)O₂ crystals and/or Li(Ni, Co, Al)O₂ crystals may be used alone as the positive electrode active material, or Li(Ni, Co, Mn)O₂ crystals and/or Li(Ni, Co, Al)O₂ crystals whose full width at half maximum for the diffraction peak of the (003) plane as measured by X-ray diffraction is greater than 0.00° and 0.10° or less may be mixed with another positive electrode material as long as the amount relative to the total mass of the positive electrode active material is within the range of 20% by mass or more and 100% by mass or less.

A positive electrode active material mentioned above, a known conductive aid, and a known binder are mixed together to obtain a positive electrode mixture. The mixing ratio may be, for example, 50% by mass or more and 99% by mass or less of the positive electrode active material, 0.5% by mass or more and 30% by mass or less of the conductive aid, and 0.5% by mass or more and 30% by mass or less of the binder relative to the entire mass of the positive electrode mixture. The resulting positive electrode mixture is applied to one side of the positive electrode collector, and then press-molded. The resulting molded material is punched to a predetermined size to obtain a positive electrode 120.

Next, a separator 140 with the configuration described above is prepared. The separator 140 may be produced using any method common in the art, or a commercially available one may be used.

Next, a negative electrode material, such as metal foil (such as electrolytic Cu foil) with a thickness of 1 μm or more and 1 mm or less, is washed with a solvent containing sulfamic acid, punched out to a predetermined size, washed again ultrasonically with ethanol, and then dried to obtain the negative electrode 130.

The positive electrode collector 110, the positive electrode 120, the separator 140, and the negative electrode 130 described above are laminated in this order to obtain a laminate. The resulting laminate is then sealed in a sealed container together with an electrolytic solution to obtain a lithium secondary battery 100. There are no particular restrictions on the sealed container used in the sealing step. An example is laminated film.

### 2nd Embodiment

### Lithium Secondary Battery

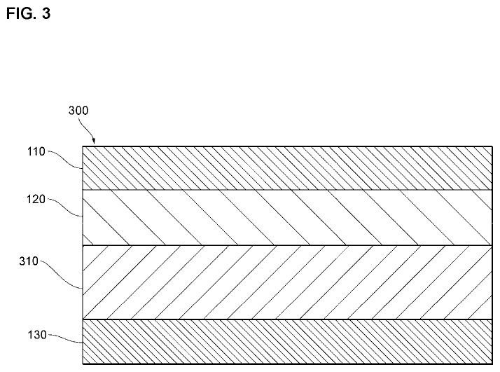

FIG. 3 is a schematic cross-sectional view of the lithium secondary battery in a second embodiment of the present invention. As shown in FIG. 3, the lithium secondary battery 300 in the second embodiment comprises the positive electrode current collector 110, the positive electrode 120 formed on one side of the positive electrode current collector 110 and including the positive electrode active material, the negative electrode 130 free of a negative electrode active material, and a solid electrolyte 310 disposed between the positive electrode 120 and the negative electrode 130. The configurations and preferred aspects of the positive electrode current collector 110, the positive electrode 120, and the negative electrode 130 are the same as those of the lithium secondary battery 100 in the first embodiment, except with respect to the points described later. This lithium secondary battery 300 has the same effects as the lithium secondary battery 100 described earlier.

### Solid Electrolyte

In general, in a battery containing an electrolytic solution, the physical pressure applied by the electrolytic solution to the surface of the negative electrode tends to vary locally due to fluctuations in the liquid. However, because this lithium secondary battery 300 includes the solid electrolyte 310, the pressure applied to the surface of the negative electrode 130 from the solid electrolyte 310 is more uniform, and the shape of the carrier metal deposited on the surface of the negative electrode 130 is more uniform. Because the carrier metal deposited on the surface of the negative electrode 130 in this aspect of the present invention is kept from growing in the form of dendrites, the cycle characteristics of the lithium secondary battery 300 are further improved.

There are no particular restrictions on the solid electrolyte 310 as long as it can be commonly used in lithium solid-state secondary batteries. A material for the solid electrolyte 310 can be selected depending on the intended application of the lithium secondary battery 300 and the type of carrier metal used. Preferably, the solid electrolyte 310 has ionic conductivity and no electron conductivity. When the solid electrolyte 310 has ionic conductivity and no electron conductivity, the internal resistance in the lithium secondary battery 300 is further reduced and short-circuiting inside the lithium secondary battery 300 is further suppressed. As a result, the lithium secondary battery 300 has a higher energy density and capacity and even better cycle characteristics.

There are no particular restrictions on the solid electrolyte 310. Examples of the solid electrolyte 310 include, for example, a solid electrolyte including resins and lithium salts. Examples of the resins include, but are not limited to, resins having an ethylene oxide unit in a main chain and/or a side chain, acrylic resins, vinyl resins, ester resins, nylon resins, polysiloxanes, polyphosphazene, polyvinylidene fluoride, polymethyl methacrylate, polyamides, polyimides, aramids, polylactic acid, polyethylenes, polystyrenes, polyurethanes, polypropylenes, polybutylenes, polyacetals, polysulfones, and polytetrafluoroethylene. These resins can be used alone or in combinations of two or more.

Examples of lithium salts that are included in the solid electrolyte 310 include, but are not limited to, LiI, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiB(O₂C₂H₄)₂, LiB(O₂C₂H₄)F₂, LiB(OCOCF₃)₄, LiNO₃, and Li₂SO₄. These lithium salts may be used alone or in combinations of two or more.

Generally, the ratio of resin to lithium salt in the solid polymer electrolyte layer is determined by the ratio of oxygen atoms in the resin to lithium atoms in the lithium salt ([Li]/[O]). In the solid electrolyte 310 of the present embodiment, the ratio of resin to lithium salt in terms of the ([Li]/[O]) ratio is preferably 0.02 or more and 0.20 or less, more preferably 0.03 or more and 0.15 or less, and even more preferably 0.04 or more and 0.12 or less.

The solid electrolyte 310 may contain components other than the resins and lithium salts mentioned above. Examples of the components include, but are not limited to, solvents and salts other than lithium salts. Examples of the salts other than lithium salts include, but are not limited to, Li, Na, K, Ca, and Mg salts.

There are no particular restrictions on the solvent. Examples of the solvent include of the solvents used in the electrolytic solution of the lithium secondary battery 100 mentioned above.

The average thickness of solid electrolyte 310 is preferably 20 μm or less, more preferably 18 μm or less, and even more preferably 15 μm or less. In this aspect of the present invention, because the volume occupied by the solid electrolyte 310 in the lithium secondary battery 300 is reduced, the energy density of the lithium secondary battery 300 is further improved. The average thickness of solid electrolyte 310 is also preferably 5 μm or more, more preferably 7 μm or more, and even more preferably 10 μm or more. In this aspect of the present invention, the positive electrode 120 and the negative electrode 130 can be separated more reliably, and short circuiting of the battery can be further suppressed.

In the present specification, “solid electrolyte” includes gel electrolytes. Examples of the gel electrolytes include, but are not limited to, those containing polymers, organic solvents, and lithium salts. Examples of the polymers that can be used in the gel electrolyte include, but are not limited to, copolymers of polyethylene and/or polyethylene oxide, polyvinylidene fluoride, and copolymers of polyvinylidene fluoride and hexafluoropropylene.

A solid electrolyte interface layer (SEI layer) may be formed on the surface of the negative electrode 130 in FIG. 3. There are no particular restrictions on the SEI layer that is formed, but it may contain, for example, a lithium-containing inorganic compound and a lithium-containing organic compound. The typical average thickness of the SEI layer is 1 nm or more and 10 μm or less. When an SEI layer is formed in the lithium secondary battery 300, the deposited layer may precipitate at the interface between the negative electrode 130 and the SEI layer, and may precipitate at the interface between the SEI layer and the solid electrolyte 310.

### Secondary Battery Production Method

The lithium secondary battery 300 can be produced in the same manner as the method for producing a lithium secondary battery 100 of the first embodiment described above, except that the solid electrolyte is used instead of the separator.

There are no particular restrictions on the method used to produce the solid electrolyte 310, as long as the method produces the solid electrolyte 310 described above. A resin and salt commonly used in a solid electrolyte (such as the resins and lithium salts in the solid electrolyte 310 described above) above are dissolved in an organic solvent. The resulting solution is then cast on a molding substrate to a predetermined thickness to obtain the solid electrolyte 310. Here, the mixing ratio of the resin and the lithium salt may be determined based on the ratio ([Li]/[O]) of the oxygen atoms in the resin and the lithium atoms in the lithium salt, as described above. This ratio ([Li]/[O]) may be, for example, 0.02 or more and 0.20 or less. There are no particular restrictions on the organic solvent that is used, which may be, for example, acetonitrile. There are no particular restrictions on the molding substrate that is used, which may be, for example, a PET film or a glass substrate.

The embodiments described above are provided merely to explain the present invention and are not intended to limit the present invention to the embodiments. Various modifications are possible without departing from the scope and spirit of the present invention.

For example, in the lithium secondary battery 100 of the first embodiment and the lithium secondary battery 300 of the second embodiment, the positive electrode 120 may be formed on both sides of the positive electrode current collector 110. In this case, the lithium secondary battery has two positive electrodes 120, two negative electrodes 130 arranged to face each of the positive electrodes 120, and two separators 140 or solid electrolytes 310 arranged between the positive electrodes 120 and the negative electrodes 130. This aspect of the present invention can improve the capacity of the lithium secondary battery even further.

The lithium secondary battery of the embodiments may be a solid-state lithium secondary battery. Because it is not necessary to use an electrolytic solution in this aspect of the present invention, the problem of electrolytic solution leakage does not occur, and the safety of the battery is further improved.

In the lithium secondary batteries described in the embodiments, there may be no lithium foil formed between the separator or the solid electrolyte and the negative electrode prior to the initial charge. When lithium foil is not formed between the separator or solid electrolyte and the negative electrode in the lithium secondary battery of the embodiments prior to the initial charge, highly flammable lithium metal are not used during production, and the lithium secondary battery with better safety and higher productivity is realized.

The lithium secondary battery in this embodiment may have a current collector arranged so as to be in contact with the negative electrode. There are no particular restrictions on the current collectors, which may be, for example, any current collector made of the negative electrode materials. When the lithium secondary battery does not have a negative electrode current collector, the negative electrode itself acts as the current collector.

In the lithium secondary battery of the present embodiment, terminals used to connect an external circuit may be attached to the positive electrode current collector and the negative electrode. For example, a metal terminal (for example, Al, Ni, etc.) of 10 μm or more and 1 mm or less may be joined to one or both of the positive electrode current collector and the negative electrode. The joining method may be any method common in the art, such as ultrasonic welding.

In the present specification, “the energy density is high” and “high energy density” mean the capacity is high relative to the total volume or total mass of the battery. This is preferably 900 Wh/L or more or 400 Wh/kg or more, and more preferably 1000 Wh/L or more or 430 Wh/kg or more.

In the present specification, “excellent cycle characteristics” means that the rate of decline in battery capacity is low after the number of times of charging and discharging cycles that can be expected during normal use. In other words, when comparing the initial capacity to the capacity after the number of times of charging and discharging cycles that can be expected during normal use, the capacity after the charging and discharging cycles has not declined significantly relative to the initial capacity. Here, “the number of times that can be expected during normal use” can be, for example, 30 times, 50 times, 100 times, 300 times, 500 times, or 1,000 times, depending on the application for the lithium secondary battery. The “capacity after the charging and discharging cycles not declining significantly relative to the initial capacity” depends on the application for the lithium secondary battery. For example, it may mean that the capacity after the charge/discharge cycles is 65% or more, 70% or more, 75% or more, 80% or more, 85% or more, or 90% or more of the initial capacity.

### Examples

The following is a more detailed description of the present invention with reference to examples and comparative examples. The present invention is not limited in any way by these examples.

### Powder X-Ray Diffraction Measurements

The Li(Ni, Co, Mn)O₂ and Li (Ni, Co, Al) O₂ crystals used in the examples and comparative examples were subjected to the following X-ray diffraction measurement to determine the respective full width at half maximum of the diffraction peak of the (003) plane.

First, the frame of a glass sample plate was filled with the positive electrode active material powder, and the surface of the powder was leveled using a glass plate. Then, each sample was measured using an X'Pert-Pro (Philips/PANalytical) powder X-ray diffractometer under the following conditions.

Beam source: CuKα

X-ray output: 45 kV, 40 mA
Scanning range: 100≤2θ≤60°
Sampling interval: 0.0040°/step
Scanning step time: 15.24 seconds
Divergence slit (aperture angle): 0.25°
Focus-DS distance: 100.00 mm

The resulting X-ray diffraction spectrum was then subjected to removal of diffraction peak by Kα2 rays and diffraction peak smoothing using a powder X-ray diffraction pattern analysis software provided with the X-ray diffractometer. Afterward, the full width at half maximum of the diffraction peak attributed to the (003) plane was determined.

### Example 1

LiNi_{0.85}Co_{0.12}Mn_{0.03}O₂ powder was purchased for use as the positive electrode active material. The full width at half maximum for the diffraction peak of the (003) plane of the Li (Ni, Co, Al) O₂ as measured by X-ray diffraction was 0.03°. (The “full width at half maximum for the diffraction peak of the (003) plane” is simply referred to as the “half width” below.)

Next, 12 μm Al foil was prepared as a positive electrode current collector. Then, a mixture of 96 parts by mass of positive electrode active material, 2 parts by mass carbon black conductive agent, and 2 parts by mass polyvinylidene fluoride (PVDF) binder was applied to one side of the positive electrode current collector and press molded. The resulting molded object was punched out to obtain a 4.0 cm×4.0 cm molded object with the positive electrode formed on one side of the positive electrode current collector.

Next, 10 μm electrolytic Cu foil was washed with a solvent containing sulfamic acid, punched to a size of 4.5 cm×4.5 cm, washed ultrasonically with ethanol, and then dried to obtain a negative electrode.

A 12 μm polyethylene microporous film coated on both sides thereof with 2 μm of polyvinylidene fluoride (PVDF) was prepared as a 5.0 cm×5.0 cm separator.

4M LiN(SO₂F)₂ (“LFSI” below) solution in dimethoxyethane (“DME” below) was prepared as electrolytic solution.

The positive electrode current collector, positive electrode, separator, and negative electrode described above were laminated in this order to obtain a laminate. A 100 μm Al terminal and a 100 μm Ni terminal were connected to the positive electrode current collector and the negative electrode, respectively, by ultrasonic welding, before inserting the laminate into an outer casing. Next, the electrolytic solution described above was injected into the outer casing. The outer casing was then sealed to obtain a lithium secondary battery.

### Example 2

A lithium secondary battery was obtained in the same manner as Example 1 except that LiNi_{0.85}Co_{0.12}Mn_{0.03}O₂ (half width: 0.08°) was used as the positive electrode active material.

### Example 3

A lithium secondary battery was obtained in the same manner as Example 1 except that a mixture of 50 parts by mass of LiNi_{0.85}Co_{0.12}Mn_{0.03}O₂ (half width: 0.08°) and 50 parts by mass of LiNi_{0.85}Co_{0.12}Mn_{0.03}O₂ (half width: 0.12°) was used as the positive electrode active material.

### Example 4

A lithium secondary battery was obtained in the same manner as Example 1 except that a mixture of 20 parts by mass of LiNi_{0.85}Co_{0.12}Mn_{0.03}O₂ (half width: 0.08°) and 80 parts by mass of LiNi_{0.85}Co_{0.12}Mn_{0.03}O₂ (half width: 0.12°) was used as the positive electrode active material.

### Example 5

A lithium secondary battery was obtained in the same manner as Example 1 except that a mixture of 50 parts by mass of LiNi_{0.85}Co_{0.12}Mn_{0.03}O₂ (half width: 0.08°) and 50 parts by mass of LiNi_{0.80}Co_{0.15}Al_{0.05}O₂ (half width: 0.12°) was used as the positive electrode active material.

### Example 6

A lithium secondary battery was obtained in the same manner as Example 1 except that a mixture of 50 parts by mass of LiNi_{0.80}Co_{0.12}Al_{0.05}O₂ (half width: 0.08°) and 50 parts by mass of LiNi_{0.85}Co_{0.15}Mn_{0.03}O₂ (half width: 0.12°) was used as the positive electrode active material.

### Comparative Example 1

A lithium secondary battery was obtained in the same manner as Example 1 except that LiNi_{0.85}Co_{0.12}Mn_{0.03}O₂ (half width: 0.12°) was used as the positive electrode active material.

### Comparative Example 2

A lithium secondary battery was obtained in the same manner as Example 1 except that a mixture of 10 parts by mass of LiNi_{0.85}Co_{0.12}Mn_{0.03}O₂ (half width: 0.08°) and 90 parts by mass of LiNi_{0.85}Co_{0.12}Mn_{0.03}O₂ (half width: 0.12°) was used as the positive electrode active material.

### Evaluation of Energy Density and Cycle Characteristics

The secondary batteries produced in the examples and the comparative examples were charged and discharged 50 times and thereby evaluating their cycle characteristics in the manner described below.

In the first cycle, the secondary battery was charged at 3.2 mA until the voltage reached 4.2 V (the “initial charge” below), and then discharged at 3.2 mA until the voltage reached 3.0 V (the “initial discharge” below). In the 2nd to 50th cycles, the battery was charged at 16 mA until the voltage reached 4.2 V, and then discharged at 32 mA until the voltage reached 3.0 V. The temperature was kept at 25° C. during all cycles.

The ratio of the amount of electricity that flowed during initial discharge (initial discharge capacity) to the amount of electricity that flowed during initial charge (initial charge capacity), initial discharge capacity/initial charge capacity, was calculated for each example. This ratio (initial discharge capacity/initial charge capacity) is shown in Table 1 as the initial charge/discharge efficiency (%).

Also, the ratio of the capacity obtained from the 50th cycle discharge (50th cycle capacity) to the capacity obtained from the 2nd cycle discharge (2nd cycle capacity), 50th cycle capacity/2nd cycle capacity, was determined. This ratio (capacity at 50th cycle/capacity at 2nd cycle) is shown in Table 1 as the capacity retention (%). The initial charge capacity was 100 mAh in all examples.

TABLE 1

| | | | | | | | | Initial |
|---|---|---|---|---|---|---|---|---|
| | Positive Electrode Active Material | | | | | | | Charge/ |
| | 0.00 < Half Width Value ≤ 0.10 | | | Half Width Value > 0.10 | | | Capacity | Discharge |
| | | Half Width | Amt. | | Half Width | Amt. | Retention | Efficiency |
| Sample No. | Composition | (°) | (%) | Composition | (°) | (%) | (%) | (%) |
| Ex. 1 | LiNi_{0.85}Co_{0.12}Mn_{0.03}O₂ | 0.03 | 100 | — | — | 0 | 90 | 85 |
| Ex. 2 | LiNi_{0.85}Co_{0.12}Mn_{0.03}O₂ | 0.08 | 100 | — | — | 0 | 92 | 87 |
| Ex. 3 | LiNi_{0.85}Co_{0.12}Mn_{0.03}O₂ | 0.08 | 50 | LiNi_{0.85}Co_{0.12}Mn_{0.03}O₂ | 0.12 | 50 | 88 | 86 |
| Ex. 4 | LiNi_{0.85}Co_{0.12}Mn_{0.03}O₂ | 0.08 | 20 | LiNi_{0.85}Co_{0.12}Mn_{0.03}O₂ | 0.12 | 80 | 82 | 88 |
| Ex. 5 | LiNi_{0.85}Co_{0.12}Mn_{0.03}O₂ | 0.08 | 50 | LiNi_{0.80}Co_{0.15}Al_{0.05}O₂ | 0.12 | 50 | 87 | 87 |
| Ex. 6 | LiNi_{0.80}Co_{0.15}Al_{0.05}O₂ | 0.08 | 50 | LiNi_{0.85}Co_{0.12}Mn_{0.03}O₂ | 0.12 | 50 | 88 | 87 |
| C. Ex. 1 | — | — | 0 | LiNi_{0.85}Co_{0.12}Mn_{0.03}O₂ | 0.12 | 100 | 70 | 91 |
| C. Ex. 2 | LiNi_{0.85}Co_{0.12}Mn_{0.03}O₂ | 0.08 | 10 | LiNi_{0.85}Co_{0.12}Mn_{0.03}O₂ | 0.12 | 90 | 72 | 90 |

It is clear from Table 1 that Examples 1 to 6, which contained Li (Ni, Co, Mn)O₂ and/or Li (Ni, Co, Al) O₂ with a half width of greater than 0.00° and 0.10° or less in an amount of 20% by mass relative to the overall mass of the positive electrode active material, had a higher capacity retention and excellent cycle characteristics compared with Comparative Examples 1 and 2, which did not contain. It can also be seen from Table 1 that Examples 1 to 6 have a lower initial charge/discharge efficiency than Comparative Examples 1 and 2. These results suggest that a factor in the excellent cycle characteristics of Examples 1 to 6, which contained a positive electrode active material with high crystallinity at a predetermined ratio, is that a certain amount of lithium metal remains on the negative electrode even after the discharge is completed, promoting uniform deposition of lithium metal.

### Influence of Charging Conditions

The effect of charging conditions on the cycle characteristics of secondary batteries was investigated by charging and discharging the secondary batteries produced in Example 2 and Comparative Example 1 50 times under different conditions (Cycle Conditions 1 and Cycle Condition 2 below).

### Cycle Conditions 1

In the first cycle, the secondary battery was charged at 3.2 mA until the voltage reached 4.2 V (the “initial charge” below), and then discharged at 3.2 mA until the voltage reached 3.0 V (the “initial discharge” below). In the 2nd to 50th cycles, the battery was charged at 16 mA until the voltage reached 4.2 V, and then discharged at 32 mA until the voltage reached 3.0 V. The temperature was kept at 25° C. during all cycles.

### Cycle Conditions 2

In the first cycle, the secondary battery was charged at 3.2 mA until the voltage reached 4.4 V (the “initial charge” below), and then discharged at 3.2 mA until the voltage reached 3.0 V (the “initial discharge” below). In the 2nd to 50th cycles, the battery was charged at 16 mA until the voltage reached 4.4 V, and then discharged at 32 mA until the voltage reached 3.0 V. The temperature was kept at 25° C. during all cycles.

In each measurement, the initial charge/discharge efficiency (%) and the capacity retention (%) were determined in the same manner as above. The results are shown in Table 2.

TABLE 2

| | | Capacity | Initial Charge/ |
|---|---|---|---|
| | Cycle | Retention | Discharge Efficiency |
| Sample No. | Conditions | (%) | (%) |
| Example 2 | Conditions 1 | 92 | 87 |
| | Conditions 2 | 94 | 84 |
| Comparative | Conditions 1 | 70 | 91 |
| Example 1 | Conditions 2 | 68 | 85 |

It is clear from Table 2 that in the case of both Example 2 and Comparative Example 1, the initial charge/discharge efficiency is lower when charging and discharging is repeated under Cycle Conditions 2 than under Cycle Conditions 1. This suggests that the percentage of lithium metal remaining after the end of a discharge increased when charging was performed under high voltage conditions. However, the capacity retention is higher for Example 2 under Cycle Conditions 2 and higher under Cycle Conditions 1 for Comparative Example 1. While charging under high voltage conditions increases the percentage of lithium metal remaining after the discharge ends, it seems that the performance of the positive electrode active material deteriorated significantly in the case of Comparative Example 1 due to the application of a high voltage to a positive electrode active material with low crystallinity, and the cycle characteristics decreased overall. Meanwhile, Example 2 appears to have experienced almost no deterioration in the performance of the positive electrode active material due to the application of high voltage to the positive electrode active material, and so the cycle characteristics improved.

### INDUSTRIAL APPLICABILITY

Because a lithium secondary battery of the present invention has high energy density and excellent cycle characteristics, it has industrial applicability as a power storage device used in various applications.

### REFERENCE SIGNS LIST

100, 300: Lithium secondary battery, 110: Positive electrode current collector, 120: Positive electrode, 130: Negative electrode, 140: Separator, 210: Solid electrolyte interface layer 220: Positive electrode terminal, 230: Negative electrode terminal, 310: Solid electrolyte

1. A lithium secondary battery comprising: a positive electrode current collector; a positive electrode formed on at least one surface of the positive electrode current collector and having a positive electrode active material; a negative electrode free of a negative electrode active material; and a separator or solid electrolyte disposed between the positive electrode and the negative electrode,
wherein the positive electrode comprises a Li(Ni, Co, Mn)O₂ crystal and/or a Li(Ni, Co, Al)O₂ crystal whose full width at half maximum for the diffraction peak of the (003) plane as measured by X-ray diffraction is greater than 0.00° and 0.10° or less in an amount of 20% by mass or more and 100% by mass or less relative to the total mass of the positive electrode active material.

2. The lithium secondary battery according to claim 1, wherein the Li(Ni, Co, Mn)O₂ is LiNi_{1-x-y}CoₓMn_{y}O₂ (where 0.05≤x≤0.20 and 0.01≤y≤0.15),
and the Li(Ni, Co, Al)O₂ is LiNi_{1-x-y}CoₓAl_{y}O₂ (where 0.05≤x≤0.20 and 0.01≤y≤0.15).

3. The lithium secondary battery according to claim 1, wherein the amount of positive electrode active material relative to the overall mass of the positive electrode is 50% by mass or more and 100% by mass or less.

4. The lithium secondary battery according to claim 1, wherein the lithium secondary battery is a lithium secondary battery in which charging and discharging are performed by depositing lithium metal on the surface of the negative electrode and dissolving the deposited lithium.

5. The lithium secondary battery according to claim 1, wherein the negative electrode is an electrode consisting of at least one selected from the group consisting of Cu, Ni, Ti, Fe, other metals that do not react with Li, alloys of these, and stainless steel (SUS).

6. The lithium secondary battery according to claim 1, wherein lithium foil is not formed on the surface of the negative electrode before initial charging.

7. A method for using the lithium secondary battery according to claim 1 under charging conditions of 4.4 V or more.
